(19) United States
(12) Patent Application Publication
(10) Pub. No.: US 2012/0291726 A1
(43) Pub. Date: Nov. 22, 2012

(54) CYLINDER BLOCK FOR A LIQUID-COOLED INTERNAL-COMBUSTION ENGINE

(75) Inventors: Giampaolo GALEAZZI, Torino (IT); Antonio ABOZZI, Torino (IT)

(73) Assignee: FIAT POWERTRAIN TECHNOLOGIES S.P.A., Torino (IT)

(21) Appl. No.: 13/464,621

(22) Filed: May 4, 2012

(30) Foreign Application Priority Data
May 17, 2011 (EP) 11166337.3

(51) Int. Cl. F02F 1/14

(52) U.S. Cl. 123/41.72

(57) ABSTRACT

A cylinder block for an internal-combustion engine includes a first cavity and a second cavity adapted to contain a cooling liquid extend around respective portions of the cylinder. The first cavity of each cylinder communicates hydraulically with the first cavity of at least one adjacent cylinder to define a first cooling jacket. The second cavity of each cylinder communicates hydraulically with the second cavity of at least one adjacent cylinder to define a second cooling jacket. The first and the second cooling jackets each are in fluid communication with a second supply channel. Each of the supply channels is in fluid communication with a supply source with a direction of flow such that the cooling liquid goes towards the first and second cooling jackets, coming out through the top face.

### CROSS REFERENCE TO RELATED APPLICATION

This application claims priority from European Patent Application No. 11166337.3 filed on May 17, 2011, the entire disclosure of which is incorporated herein by reference.

### TEXT OF THE DESCRIPTION

### Field of the Invention

The present invention relates to cylinder blocks for liquid-cooled internal-combustion engines.

In particular, the present invention regards a cylinder block for an internal-combustion engine of the type comprising:
a body including a top face, two end faces, two side faces, and a bottom face, where the side faces develop substantially in a longitudinal direction of the cylinder block; and
a plurality of cylinders traversing the cylinder block from the top face to the bottom face, where the cylinders are arranged in the longitudinal direction of the cylinder block itself;

wherein to each cylinder there are associated a first cavity and a second cavity, adapted to contain a cooling liquid, which extend around respective portions of the cylinder itself with a substantially arched geometry, wherein the first and the second cavities open out at the top face and are closed by a wall in the proximity of the bottom face,

wherein the first and second cavities of each cylinder are separate from one another,

wherein the first cavity of each cylinder is hydraulically communicating with the first cavity of at least one adjacent cylinder so as to define a first cooling jacket,

wherein the second cavity of each cylinder is hydraulically communicating with the second cavity of at least one adjacent cylinder so as to define a second cooling jacket,

wherein the first and second cooling jackets develop substantially in said longitudinal direction along two sides of the plurality of cylinders.

### GENERAL TECHNICAL PROBLEM

Cooling is a crucial technical problem in any design of an internal-combustion engine. In the case of liquid cooling, particular attention has been dedicated in the framework of the known art to the search for solutions that guarantee a good cooling efficiency and a temperature distribution that is as uniform as possible within the engine.

The majority of known solutions envisages the arrangement of a single cooling jacket around the cylinders of a cylinder block with supply of coolant at one of the longitudinal ends of the jacket. The cooling jacket develops around the cylinders reproducing in part the profile thereof and comprises a plurality of hydraulic passages through which the cooling liquid passes from the cooling jacket to a cylinder head of the engine.

However, in an internal-combustion engine there are marked temperature gradients due to operation of the engine itself. In particular, there is usually a region that comprises the exhaust environments of the engine such as the exhaust ducts, the exhaust manifold, and possibly a turbosupercharger assembly, which are at a temperature that is on average higher than that of a region associated to the intake environments of the engine itself, i.e., a region comprising the intake manifold and the intake ducts.

Document No. DE 10 2009 023 530 A1 proposes a solution in which provided in a cylinder block for an internal-combustion engine are two separate cooling jackets developing in a longitudinal direction, in which the first cooling jacket is hydraulically connected to a supply channel pre-arranged for receiving a cooling liquid, whereas the second jacket is hydraulically connected to an exhaust manifold pre-arranged for evacuating the cooling liquid.

The first cooling jacket is preferably set in the region comprising the exhaust environments of the internal-combustion engine, whereas the second jacket is set in the region comprising the intake environments.

The cooling liquid is made to pass through the first cooling jacket, then sent on to the head of the internal-combustion engine, and from this directed towards the second cooling jacket, from which it exits through the exhaust channel.

Said solution, however, presents a series of drawbacks. In the first place, the cooling water that enters the second jacket has already traversed the entire region comprising the exhaust environments and also the remaining part of the cylinder head so that it has a rather high temperature that may not be optimal for proper operation of the internal-combustion engine.

### OBJECT OF THE INVENTION

The object of the present invention is to overcome the technical problems described previously.

In particular, the object of the invention is to provide a cylinder block for an internal-combustion engine in which it is possible to control in an effective way the temperature gradient within the engine itself and in which, moreover, the circulation of the cooling liquid is optimized.

### SUMMARY OF THE INVENTION

The object of the present invention is achieved by a cylinder block for an internal-combustion engine having all the features listed at the beginning of the present description and moreover characterized in that the first and second cooling jackets are in fluid communication, respectively, with a first supply channel and a second supply channel, having, respectively, a first inlet port and a second inlet port, and wherein moreover the first and second supply channels are in fluid communication with a supply source from which the cooling liquid is delivered to the first and second supply channels through the first and second inlet ports with a direction of flow such that the cooling liquid goes from the first and second supply channels to the first and second cooling jackets and exits from each of said first and second cooling jackets through the top face of the cylinder block.

### BRIEF DESCRIPTION OF THE FIGURES

The invention will now be described with reference to the annexed figures, which are provided purely by way of non-limiting example and wherein:

FIG. 1 is a perspective view of a cylinder block for an internal-combustion engine according to one embodiment of the invention;

FIG. 2 is a perspective view according to the arrow II of FIG. 1;

FIG. 3 is a perspective view comprising volumes internal to the cylinder block within which cooling liquid circulates, where said volumes are represented as solid bodies;

FIG. 4 is a perspective view according to the arrow IV of FIG. 3;

FIG. 5 is a view according to the arrow V of FIG. 3;

FIG. 6 is a view according to the arrow VI of FIG. 3, substantially equivalent to that of FIG. 3 but with some components removed for the sake of clarity.

### DETAILED DESCRIPTION OF THE INVENTION

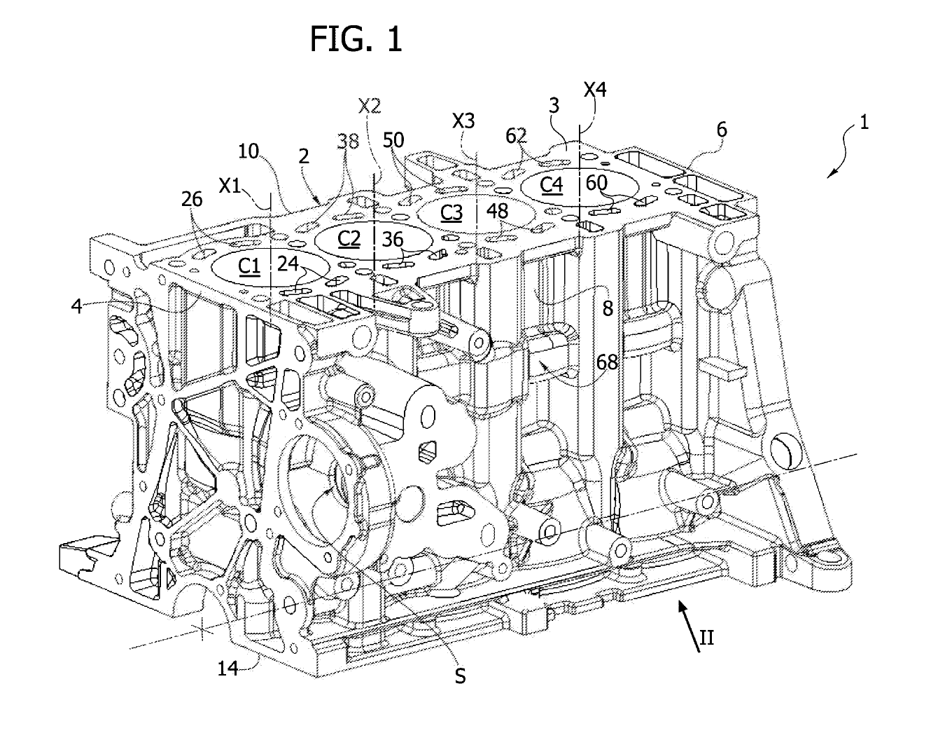

Designated by 1 in FIG. 1 is a cylinder block according to a preferred embodiment of the present invention. In the example illustrated herein, the cylinder block 1 is intended for the assembly of an engine with four cylinders in line, but a person skilled in the art will of course appreciate that the following description applies irrespectively of the number of cylinders of the engine and can moreover be applied also to engines with “V” architecture and in general to engines the architecture of which envisages a number of lines of cylinders.

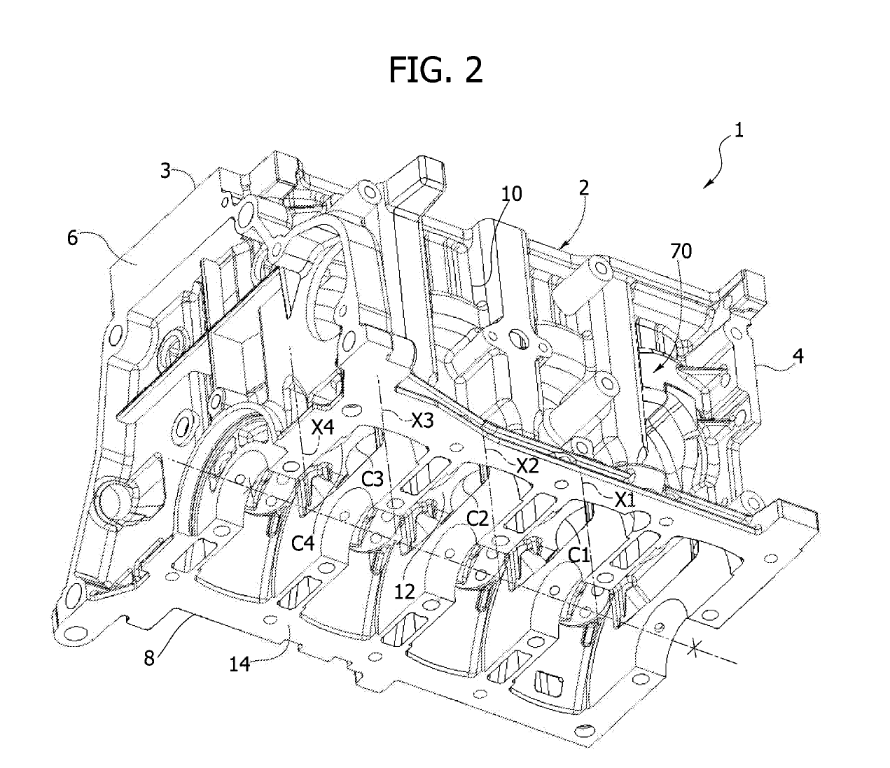

The cylinder block 1 comprises a body 2 having a top face 3, a first end face 4 and a second end face 6, a first side face 8 and a second side face 10, and a bottom face 12 (FIG. 2). Moreover located underneath the face 12 is an assembly surface, designated as a whole by the reference number 14 and designed for coupling with members for supporting a crankshaft.

The first and second side faces 8, 10 have an orientation such as to identify a longitudinal direction of the engine and of the cylinder block. Set in line in said longitudinal direction are four cylinders C1, C2, C3, C4. The cylinders C1, C2, C3, C4 traverse the cylinder block from the bottom face 12 to the top face 3, defining substantially four cylindrical through cavities provided for housing pistons of the internal-combustion engine.

The cylinders C1, C2, C3, C4 have respective axes X1, X2, X3, X4 that in this embodiment are parallel, aligned in a longitudinal direction of the cylinder block 1 and orthogonal to the top face 3.

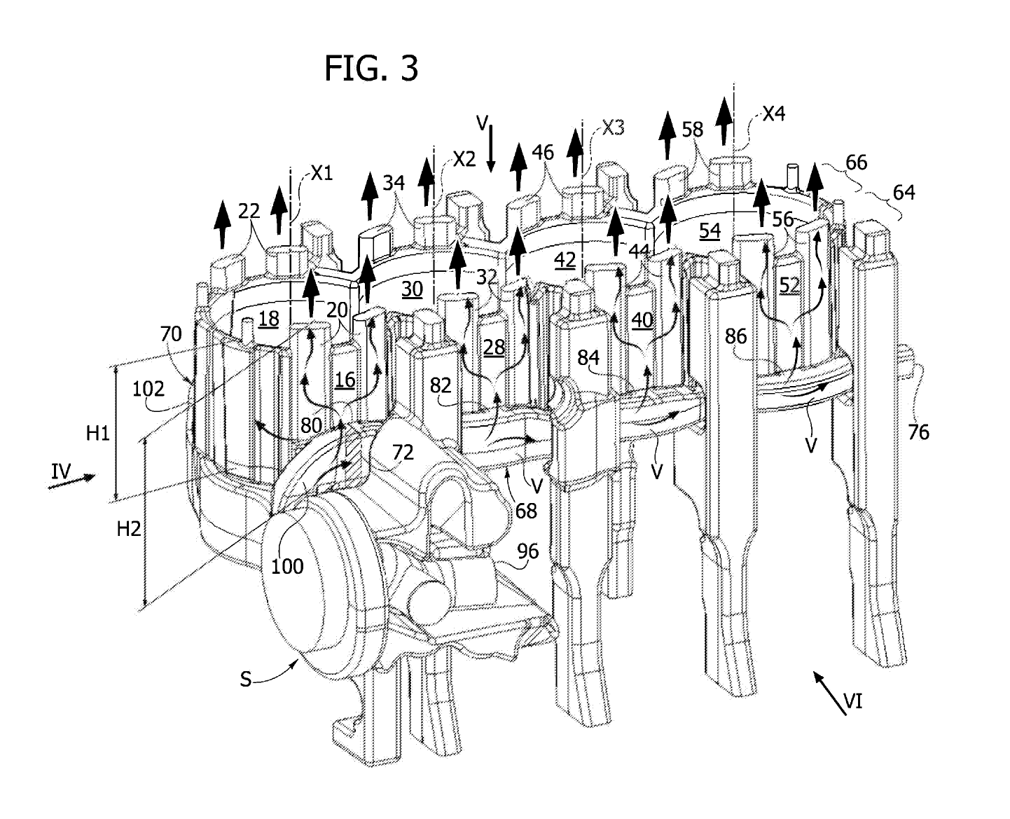

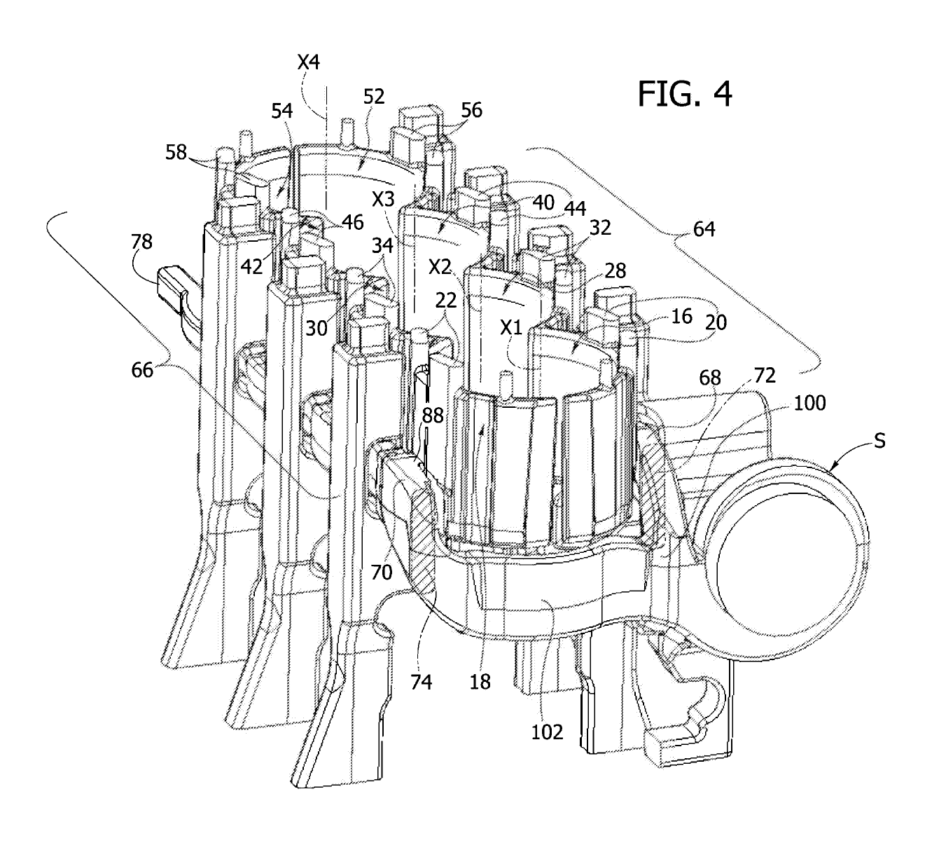

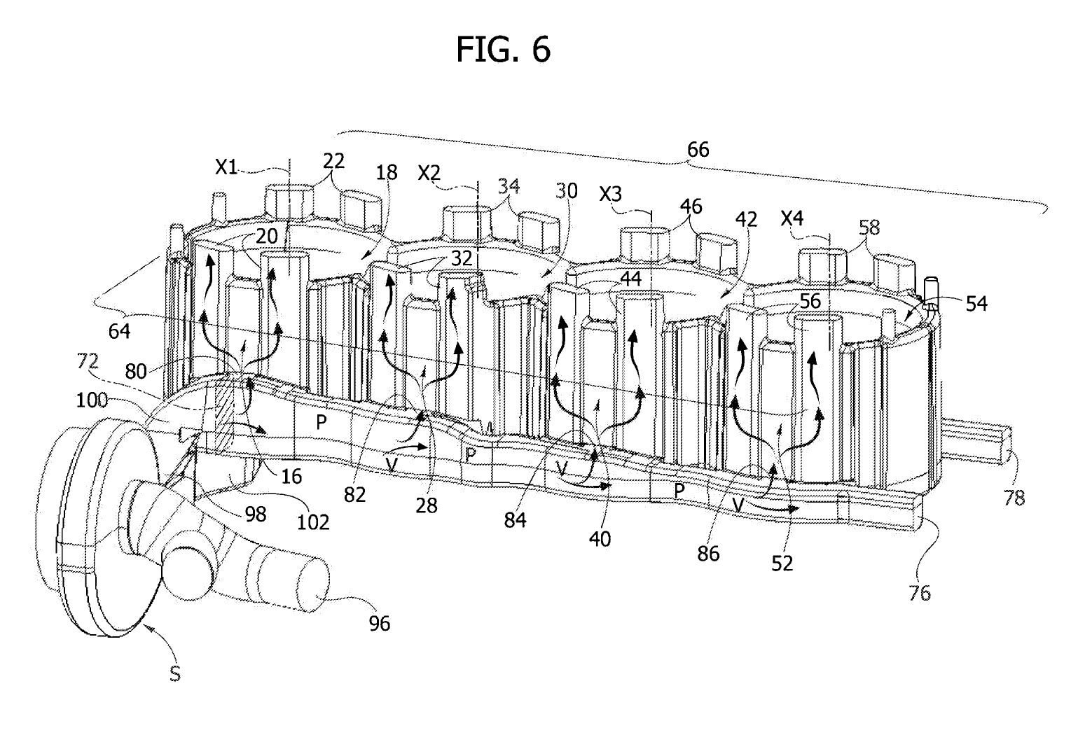

With reference to FIGS. 3 to 6, a volume of cooling liquid within the cylinder block 1 is represented as a solid body. As an aid to an understanding of the description and to identification of the position of said volume of cooling liquid within the cylinder block 1 the axes X1, X2, X3, X4 of the cylinders C1, C2, C3, C4 are represented.

With reference to FIG. 3, associated to each cylinder are a first cavity and a second cavity designed to contain the cooling liquid. With specific reference to the cylinder C1, a first cavity 16 and a second cavity 18 are associated thereto and set on opposite sides thereof.

The cavities 16, 18 extend around respective portions of the cylinder C1 with a substantially arched geometry. In particular, with reference to the specific case, each cavity 16, 18 has a shape that can be assimilated to a sector of a cylindrical annulus (with axis coinciding with the axis X1), which matches well the shape of the cylinder C1.

Each cavity 16, 18 is closed at the bottom in the proximity of the bottom face 12, whilst it opens out at the top face 3 by means of respective pairs of fluid passages designated by the reference numbers 20, 22 having a cross section of an oblong shape, which in turn results in corresponding oblong holes designated by the numbers, respectively, 24, 26, located at the top face 3.

In other words, the cavities 16, 18 extend in a direction parallel to the axis X1 for an amount H1 (which corresponds substantially to a height thereof) that is lower than the distance between the top face 3 and the bottom face 12 so that they are completely contained within the cylinder block 1, whilst only part of them, in particular the fluid passages 20, 22, extend in a direction parallel to the axis X1 for an amount H2 (once again a height) that is greater than the amount H1 but once again smaller than the distance between the faces 3 and 12.

The cavities 16, 18 are separate from one another, i.e., there is no direct fluid communication along their overall development around the cylinder C1. In other words, the overall angular extension for the cavities 16, 18 around the axis X1 and the cylinder C1 is such as to be smaller than 360°.

With the same properties, associated to the cylinders C2, C3, C4 are, respectively:
two cavities 28, 30, with respective pairs of passages for fluid 32, 34, which open out at the top face 3 with respective pairs of oblong holes 36, 38;
two cavities 40, 42 with respective pairs of passages for fluid 44, 46, which open out at the top face 3 with respective pairs of oblong holes 48, 50; and
two cavities 52, 54 with respective pairs of passages for fluid 56, 58, which open out at the top face 3 with respective pairs of oblong holes 60, 62.

In the present description, the cavities 16, 28, 40, 52 will be all referred to, individually, as “first cavities” (of course associated to the corresponding cylinder), whereas the cavities 18, 30, 42, 54 will be referred to as “second cavities”.

According to an advantageous aspect of the invention, each first cavity 16, 28, 40, 52 is, as described, separate from the corresponding second cavity 18, 30, 42, 54 but is in hydraulic communication with at least one first cavity of an adjacent cylinder. In the example considered here, the cavity 16 is in direct communication with the cavity 28, which in turn is also in direct communication with the cavity 40.

The latter is moreover in direct communication with the cavity 52, which, instead, occupies an end position, as likewise the cavity 16. The cavities 52, 16 are hence in fluid communication with just one first cavity of an adjacent cylinder, respectively 28, 40.

Likewise, the cavities 30, 42 associated to the cylinders C2, C3 (in this case internal cylinders of the cylinder block 1) are in fluid communication with two second adjacent cavities, whereas the cavities 18 and 54 occupy end positions and are hence in fluid communication with just one first cavity of an adjacent cylinder, respectively 30, 42.

It may moreover be noted that in this embodiment the adjacent and hydraulically communicating cavities have a hydraulic-communication interface that extends throughout the height H1.

There are thus defined, around the cylinders C1, C2, C3, C4, a first cooling jacket and a second cooling jacket, which are designated as a whole by the reference numbers 64, 66.

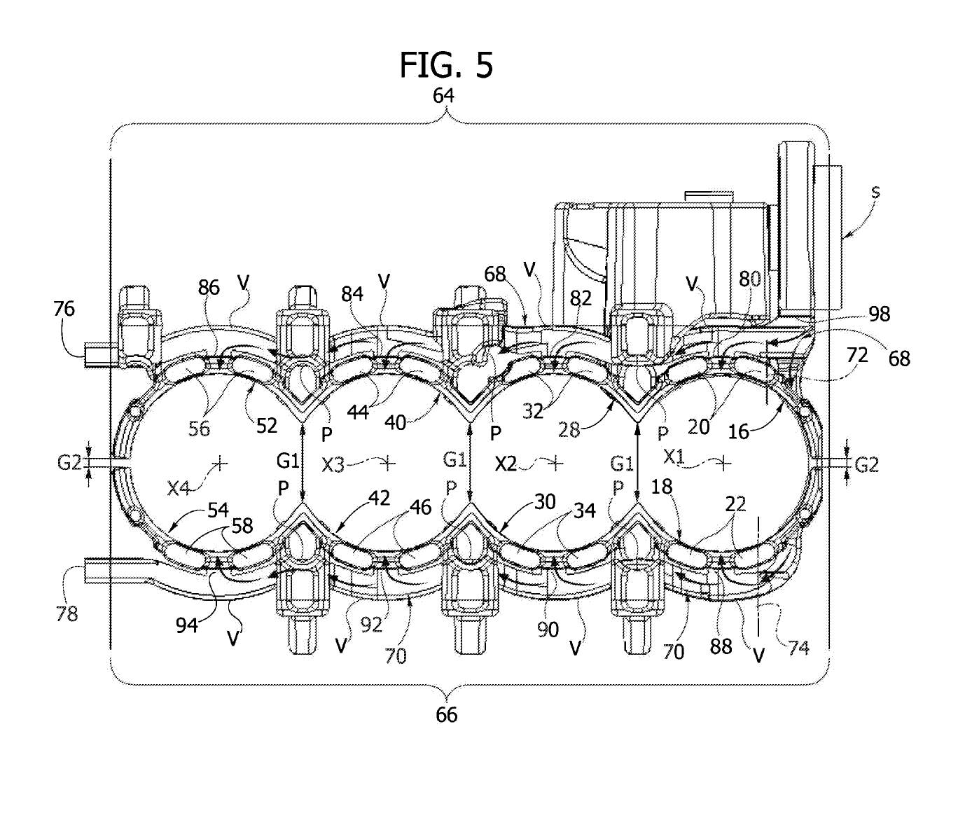

With reference in particular to FIG. 5, the first cooling jacket 64 substantially consists of the union of the cavities 16, 28, 40, 52 and it has, in plan view, a multi-arched shape defined by the union of the shapes of the aforesaid cavities. The same applies to the cooling jacket 66, except for the cavities that define it, which are the second cavities 18, 30, 42, 54.

It should moreover be noted that the cooling jackets 64, 66 develop in the longitudinal direction of the cylinder block 1 along opposite sides of the plurality of cylinders C1, C2, C3, C4 (which herein, as has been said, are arranged in line), and are separated transversely (i.e., in a direction orthogonal to the longitudinal direction of the cylinder block 1) by a minimum distance that is variable according to the position of the cavities with respect to the cylinder block 1.

In greater detail, in the portions of the cooling jackets 64, 66 comprising cavities associated to “internal” cylinders—such as for example the cylinder C2 and the cylinder C3 with the respective cavities 28, 30 and 40, 42—the minimum transverse distance is designated by G1 (in what follows “first minimum distance”) and is substantially equal, in plan view, to the distance between the cusps defined by the union of the adjacent cavities.

However, at the ends of the line of the cylinders C1, C2, C3, C4, the cooling jackets 64, 66 are separated in a transverse direction by a second minimum distance G2 smaller than the first minimum distance G1 since at the ends of the line of the cylinders C1, C2, C3, C4 the cavities have an angular extension (assuming once again as reference the axis of the corresponding cylinder) that is greater than that of the cavities associated to the internal cylinders C2-C3, there not being any spatial constraints deriving from the presence of an adjacent cavity on either side.

With reference once again to FIGS. 3 to 6, the first and second cooling jackets 64, 66 are in fluid communication, respectively, with a first supply channel 68 and a second supply channel 70. The supply channels 68, 70 extend in the longitudinal direction of the cylinder block 1 according to a substantially serpentine path that develops along the external profile of the cooling jackets 66, 64. In particular, said serpentine profile comprises a sequence of valleys alternating with peaks, where the aforesaid valleys are arched portions located at the cavities that make up the two cooling jackets, and said peaks are located at boundary areas between adjacent cavities. In FIG. 5 the valleys are designated by the letter V, whereas the peaks are designated by the letter P.

The first and second supply channels 68, 70 comprise, respectively, a first inlet port 72 and a second inlet port—which are represented here with an in situ sectional view (FIGS. 3, 4, 6) and, in other figures (FIG. 5), with a dashed and dotted line—and a first blind end 76 and a second blind end 78, which are set in an opposite position with respect to the corresponding intake mouths, respectively 72, 74.

Each supply channel 68, 70 moreover has a cross section decreasing from the intake ports 72, 74 towards the corresponding blind ends 76, 78. Moreover, each supply channel 68, 70 is in direct hydraulic communication with each of the cavities of the cooling jacket operatively associated thereto by means of branches provided along its path. In particular, the first supply channel 68 comprises a first branch 80, a second branch 82, a third branch 84, and a fourth branch 86 having a substantially transverse orientation, located at the troughs V of the channel 68 and merging into the cavities, respectively, 16, 28, 40, 52, in particular between the passages for fluid of the pairs 20, 32, 44, 56.

Likewise, the second supply channel 70 comprises a fifth branch 88, a sixth branch 90, a seventh branch 92, and an eighth branch 94, which also have a transverse orientation and merge into the corresponding cavities 18, 30, 42, 54 between the passages for fluid of the pairs 22, 34, 46, 58.

The supply channels 68, 70 are moreover in fluid communication with a supply source designated as a whole by S of which once again visible herein is a volume of fluid represented as a solid body. The supply source S is preferably a hydraulic cooling-liquid pump driven in rotation by the internal-combustion engine assembled on the cylinder block 1, which comprises an intake mouth 96 and a delivery mouth 98 from which there branches off a bifurcation comprising a first connection channel 100 and a second connection channel 102, which are hydraulically connected, respectively, to the supply channels 68, 70.

During operation of the internal-combustion engine assembled on the cylinder block 1 the cooling-liquid pump, which here has a casing provided in the cylinder block 1, is driven in rotation so that it supplies the cooling liquid to the channels 68, 70.

In particular, the supply source S (here, as described, corresponding to the cooling-liquid hydraulic pump) sends fluid to each supply channel 68, 70 through the corresponding intake ports 72, 74. In the channels 68, 70 the cooling liquid enters the cooling jackets 64, 66 penetrating through the branches 80, 82, 84, 86, 88, 90, 92, 94 directly within the first and second cavities provided around each cylinder. The direction of flow of the coolant delivered by the supply source S is such that it proceeds from the supply channels 68, 70 to the corresponding branches, and then towards the cooling jackets 64, 66, coming out therefrom through the oblong holes at which the passages for fluid of each individual cavity terminate.

In summary, the direction of flow of the fluid is such that it enters substantially at the base of each cylinder C1, C2, C3, C4 and exits therefrom at the top face 3 proceeding towards the head of the internal-combustion engine, which is installed on top of the top face 3 and has passages for fluid with an arrangement that is identical to and mates with the oblong holes on the face 3 itself.

It should be noted that the reduction in cross section of the supply channels 68, 70 towards the blind ends has the purpose of compensating for the decrease in flowrate towards the cavities that are at a greater distance from the supply source S so as to have a substantially uniform rate of the fluid within each individual cavity that constitutes the cooling jackets 64, 66. This increases the heat-exchange efficiency of the system.

With reference to FIG. 1, it should be noted that the position of the cooling jackets and of the supply channels is such that it is possible to distinguish substantially a jacket arranged at an exhaust environment of the internal-combustion engine and a jacket arranged at an intake environment of the internal-combustion engine itself. In this way, it is possible to cool said environments in a substantially independent way improving the distribution of cooling liquid around each cylinder and regularizing the flow thereof.

In fact, known solutions with a single cooling jacket and a single region in which fluid communication between the supply source and the jacket occurs can present marked lack of uniformity in the motion field and in the temperature of the cooling liquid between the cylinders located in the proximity of the supply source and the cylinders further away.

On the other hand it will be appreciated that, unlike the known solution referred to above (DE 10 2009 023 530 A1), the cooling jacket that is located at the intake side of the internal-combustion engine receives water substantially in the same conditions as that flowing towards the jacket located on the discharge end thus ruling out the possibility of onset of problems of overheating that might arise in the known solution in the case where the temperature of the water at inlet to the jacket at the intake side is too high.

Of course, the details of embodiment may vary widely with respect to what is described and illustrated herein, without thereby departing from the sphere of protection of the present invention, as defined in the annexed claims.

The person skilled in the branch will moreover appreciate that what has been described herein applies, as mentioned previously, irrespective of the number of cylinders and of the architecture of the engine in so far as the arrangement of two cooling jackets provided by hydraulically connecting cavities for cooling liquid that develop around the cylinders and supply them by means of separate supply channels may be envisaged also on engines with more than four cylinders or with a “V” architecture.

What is claimed is:

1. A cylinder block for an internal-combustion engine comprising:
a body including a top face, two end faces, two side faces, and a bottom face, said side faces substantially developing in a longitudinal direction of said cylinder block; and
a plurality of cylinders traversing said cylinder block from said top face to said bottom face, said cylinders being arranged along said longitudinal direction;
each cylinder having a first cavity and a second cavity associated thereto, said first cavity and said second cavity adapted to contain a cooling liquid and extend around respective portions of said cylinder with a substantially arched geometry, said first and second cavities opening out at said top face and being closed in the proximity of said bottom face,
said first and second cavities of each cylinder separate from one another,
said first cavity of each cylinder communicating hydraulically with the first cavity of at least one adjacent cylinder so as to define a first cooling jacket;
said second cavity of each cylinder communicating hydraulically with the second cavity of at least one adjacent cylinder so as to define a second cooling jacket; and
said first and second cooling jackets developed substantially in said longitudinal direction along two sides of said plurality of cylinders,
said first cooling jacket in fluid communication with a first supply channel having a first inlet port;
said second cooling jacket in fluid communication with a second supply channel having a second inlet port; and
each of said first and second supply channels in fluid communication with a supply source from which the cooling liquid is delivered to said first and second supply channels through said first and second inlet ports with a direction of flow such that the cooling liquid goes from said first and second supply channels towards said first and second cooling jackets and exits through said top face.

2. The cylinder block according to claim 1, wherein each of said first and second supply channels develops in said longitudinal direction substantially along the entire extension of the first and second cooling jackets.

3. The cylinder block according to claim 1, wherein the first and second supply channels comprise a plurality of branches, merging into corresponding first and second cavities of said first and second cooling jackets, wherein each branch provides a hydraulic connection between the corresponding supply channel and the corresponding cavity.

4. The cylinder block according to claim 2, wherein each of said first and second supply channels comprises a blind end.

5. The cylinder block according to claim 4, wherein each of said first and second supply channels has a passage area decreasing from the corresponding inlet port towards the corresponding blind end.

6. The cylinder block according to claim 2, wherein said first and second supply channels have a substantially serpentine development comprising a sequence of valleys alternating with peaks, wherein each valley is arranged at a cavity of said first and second cooling jackets, whereas each peak is arranged at a boundary area between adjacent cavities.

7. The cylinder block according to claim 1, wherein each of said first and second cavities develops according to a cylindrical geometry with axis coinciding with an axis of a corresponding cylinder.

8. The cylinder block according to claim 1, wherein said first and second supply channels are hydraulically connected to said supply source by means of a bifurcation provided by a first connection channel and a second connection channel which are connected, respectively, to the first inlet port and to the second inlet port of said first and second supply channels.

9. The cylinder block according to claim 8, wherein said supply source is a hydraulic pump for said cooling liquid having a casing integrated in the body of said cylinder block.

10. The cylinder block according to claim 1, wherein said first and second cooling jackets open out at said top face through oblong holes.

11. The cylinder block according to claim 2, wherein the first and second supply channels comprise a plurality of branches, merging into corresponding first and second cavities of said first and second cooling jackets, wherein each branch provides a hydraulic connection between the corresponding supply channel and the corresponding cavity.

12. The cylinder block according to claim 3, wherein each of said first and second supply channels comprises a blind end.

13. The cylinder block according to claim 3, wherein said first and second supply channels have a substantially serpentine development comprising a sequence of valleys alternating with peaks, wherein each valley is arranged at a cavity of said first and second cooling jackets, whereas each peak is arranged at a boundary area between adjacent cavities.

14. The cylinder block according to claim 4, wherein said first and second supply channels have a substantially serpentine development comprising a sequence of valleys alternating with peaks, wherein each valley is arranged at a cavity of said first and second cooling jackets, whereas each peak is arranged at a boundary area between adjacent cavities.

15. The cylinder block according to claim 5, wherein said first and second supply channels have a substantially serpentine development comprising a sequence of valleys alternating with peaks, wherein each valley is arranged at a cavity of said first and second cooling jackets, whereas each peak is arranged at a boundary area between adjacent cavities.

16. The cylinder block according to claim 2, wherein each of said first and second cavities develops according to a cylindrical geometry with axis coinciding with an axis of a corresponding cylinder.

17. The cylinder block according to claim 3, wherein each of said first and second cavities develops according to a cylindrical geometry with axis coinciding with an axis of a corresponding cylinder.

18. The cylinder block according to claim 4, wherein each of said first and second cavities develops according to a cylindrical geometry with axis coinciding with an axis of a corresponding cylinder.

19. The cylinder block according to claim 5, wherein each of said first and second cavities develops according to a cylindrical geometry with axis coinciding with an axis of a corresponding cylinder.

20. The cylinder block according to claim 6, wherein each of said first and second cavities develops according to a cylindrical geometry with axis coinciding with an axis of a corresponding cylinder.
